(19) United States
(12) Patent Application Publication
(10) Pub. No.: US 2015/0004566 A1
(43) Pub. Date: Jan. 1, 2015

(54) Camera Based Scene Recreator for Operator Coaching

(71) Applicant: Caterpillar Inc., Peoria, IL (US)

(72) Inventors: Bradley K. Bomer, Perkin, IL (US); Michael Braunstein, Washington, IL (US); Brad Van De Veer, Washington, IL (US); Zhijun Cai, Springfield, IL (US)

(21) Appl. No.: 13/927,296

(22) Filed: Jun. 26, 2013

(51) Int. Cl. G09B 19/16

(52) U.S. Cl. CPC G09B 19/167
USPC 434/62

(57) ABSTRACT

A method for coaching an operator of a machine is disclosed. The method includes the controller collecting actual data related to an operation of the machine performed by the operator. The controller determines a type of operation being performed based on the actual data. The controller compares the actual data to expected data for the type of operation. The controller flags a coaching point based on the comparison of actual data to expected data, and the controller provides an image of the machine relating to the coaching point.

### FIELD OF THE DISCLOSURE

The present disclosure relates generally to earthmoving machines and, more particularly, to systems and methods for coaching an operator of an earthmoving machine to perform an operation.

### BACKGROUND OF THE DISCLOSURE

Machines used in earthmoving, industrial and agricultural applications require considerable skill to operate. Such machines include, but are not limited to, wheel loaders, tract-type tractors, motor graders, excavators, articulated trucks, pipe layers, backhoes, and the like. Operators of such machines must generally undergo extensive training in order to understand how to safely and efficiently operate the machine.

In addition, each machine may have an ideal or expected method of operation. The ideal method of operation may, for example, be designed to enable efficient or optimal performance of the machine. However, for a variety of reasons, an operator may deviate from the ideal operating method while using the machine. For example, the operator may have limited skills, may encounter an unusual and/or challenging work environment, or may simply be fatigued. In any event, such a failure to follow the expected operating method may lower machine performance, reduce fuel efficiency, or cause other undesirable effects.

One attempted solution has been to create a system which generates a simulated environment of a worksite. For example, U.S. Pat. No. 8,139,108, entitled “Simulation System Implementing Real-Time Machine Data” and assigned to Caterpillar Inc., describes such a system. The system of the '108 patent describes a simulation system that uses real-time performance data to remotely simulate operation of a machine at a worksite. Once a controller of the system of the '108 patent generates a simulated 3-D environment of the worksite, the operator can control and move the machine about the worksite.

The present disclosure is directed to a system to improve operator skill levels. However, it should be appreciated that the solution of any particular problem is not a limitation on the scope of this disclosure or of the attached claims except to the extent expressly noted. Additionally, this background section discusses problems and solutions noted by the inventors; the inclusion of any problem or solution in this section is not an indication that the problem or solution represents known prior art except that that the contents of the indicated patent represent a publication. With respect to the identified patent, the foregoing summary thereof is not intended to alter or supplement the prior art document itself; any discrepancy or difference should be resolved by reference to the document itself.

### SUMMARY OF THE DISCLOSURE

In accordance with one aspect of the present disclosure, a method is provided for coaching an operator of a machine having a controller. In this aspect, the method comprises the controller collecting actual data related to an operation of the machine performed by the operator. The controller determines a type of operation being performed based on the actual data. The controller compares the actual data to expected data for the type of operation. The controller flags a coaching point based on the comparison of actual data to expected data, and the controller provides an image of the machine relating to the coaching point.

In accordance with another aspect of the present disclosure, a system is provided for coaching an operator of a machine. In accordance with this aspect, the system includes a controller and a display module in communication with the controller. The controller is configured to collect actual data during an operation of the machine performed by the operator, determine a type of operation being performed based on the actual data, compare the actual data to expected data for the type of operation being performed, detect a coachable action if the actual data is outside of the expected data, and provide an image of the coachable action. The display module is configured to display the image of the coachable action on an output device.

In accordance with yet another aspect of the present disclosure, a non-transitory computer readable medium is provided having stored thereon instructions which when executed by a computer cause the coaching of an operator of a machine. The non-transitory computer readable storage medium comprises, in this aspect, instructions for collecting actual data during an operation of the machine performed by the operator, instructions for determining a type of operation being performed based on the actual data, instructions for comparing actual data to expected data for the type of operation being performed, instructions for detecting a coaching point based on the comparison of actual data to expected data, instructions for storing data related to the coaching point, and instructions for displaying an image of the coaching point using the stored data.

These and other aspects and features of the disclosure will become more readily apparent upon reading the following detailed description when taken in conjunction with the accompanying drawings.

Although various features are disclosed in relation to specific exemplary embodiments, it is understood that the various features may be combined with each other, or used alone, with any of the various exemplary embodiments of the disclosure without departing from the scope of the disclosure.

### BRIEF DESCRIPTION OF THE DRAWINGS

FIG. 1 is a perspective view of a machine according to an example embodiment of the present disclosure;

FIG. 2 is a block diagram of a system for coaching an operator according to another embodiment of the present disclosure;

FIG. 3 is a schematic view of a display of the system for coaching an operator of FIG. 2, according to another embodiment of the present disclosure;

FIG. 4 is a block diagram of a system for coaching an operator according to another embodiment of the present disclosure;

FIG. 5 is a flowchart illustrating a method for coaching an operator of a machine according to another embodiment of the present disclosure; and

FIG. 6 is a perspective view of another machine according to another embodiment of the present disclosure.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides a system and method for coaching an operator of a machine. In particular, the system and method act to improve operator skill levels by monitoring an operation (e.g., loading and moving of material) of the machine performed by the operator, determining a type of operation being performed, and comparing actual data with expected data for the type of operation being performed. Based on the comparison of actual data to expected data, the controller of the system can detect a coachable action, or an action needing improvement/coaching. The system then recreates or replays the detected coachable action together with a proper technique for the action. By recreating the detected action together with the proper technique, the operator can learn from his or her own mistakes to improve their operating skills.

Reference will now be made in detail to specific embodiments or features, examples of which are illustrated in the accompanying drawings. Generally, corresponding reference numbers will be used throughout the drawings to refer to the same or corresponding parts.

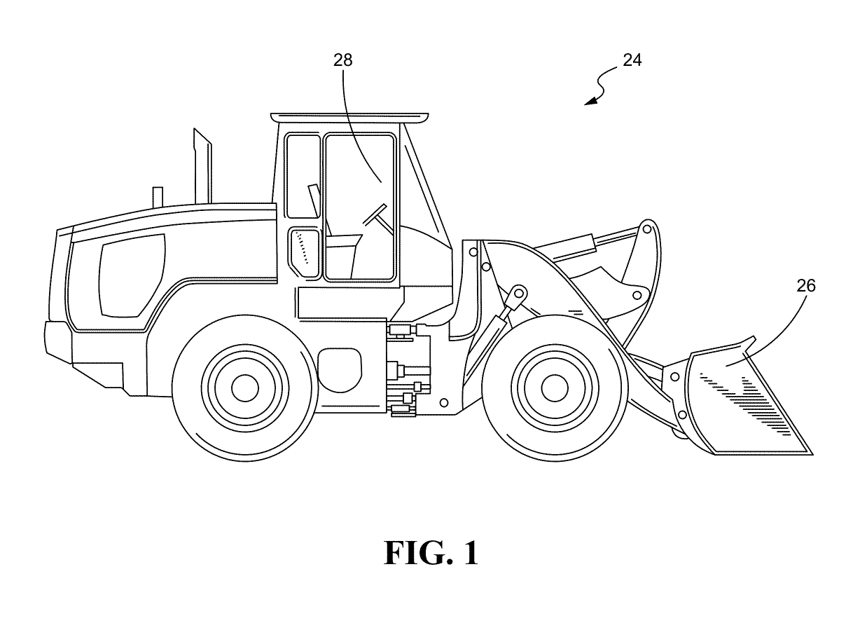

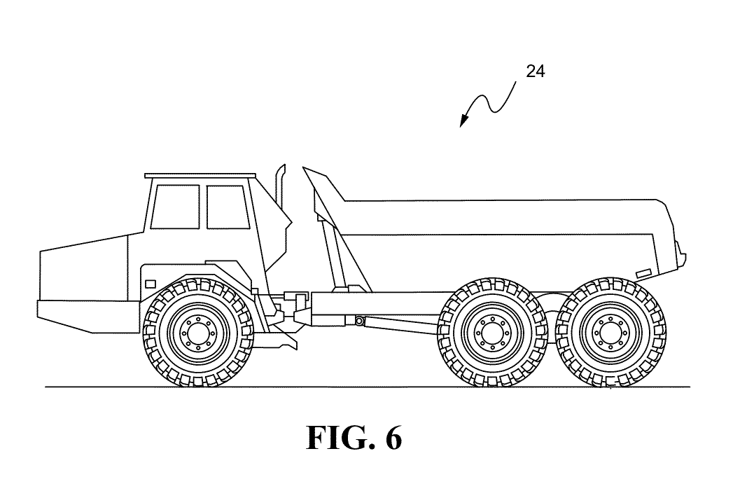

Turning now to FIGS. 1-6, although the machine 24, in FIG. 1, is shown to be a wheel loader, it will be understood that in other embodiments, the machine may be any other type of machine or vehicle, used in earthmoving, industrial or agricultural applications. For example, the machine 24 may be, without limitation, an articulated truck (as shown in FIG. 6), an excavator, a tract-type tractor, a motor grader, a pipe layer, a backhoe, or the like. It is also to be understood that the machine 24 is shown primarily for illustrative purposes to assist in disclosing features of the various embodiments, but that FIG. 1 does not depict all of the components of an exemplary machine.

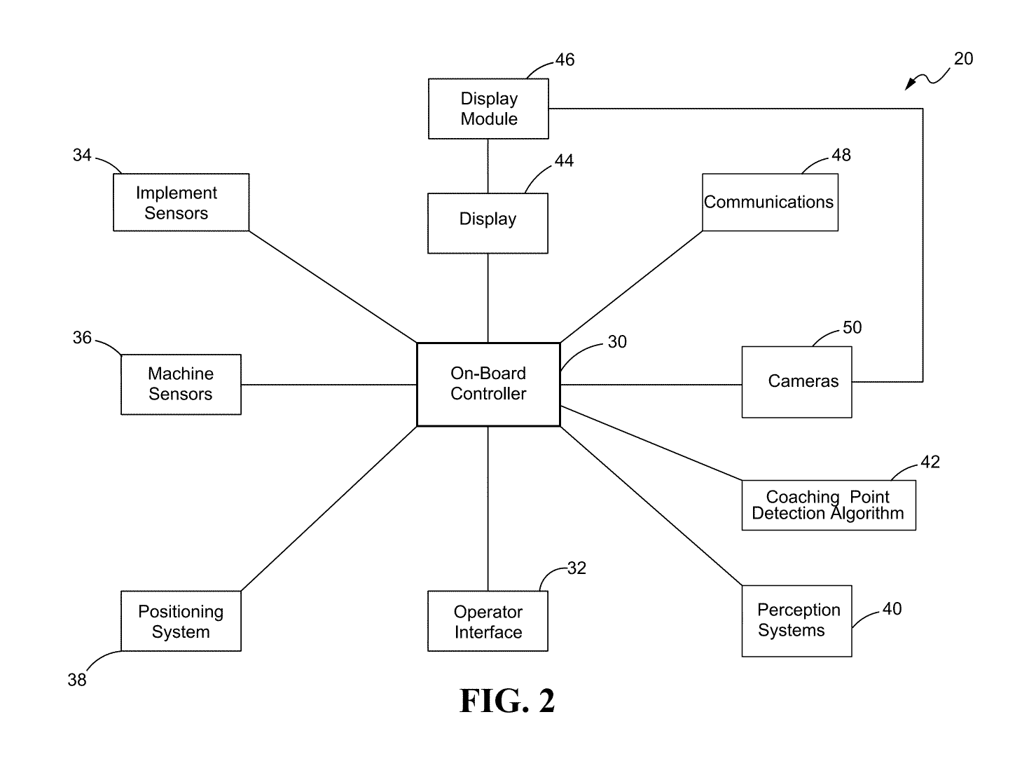

In an embodiment shown best in FIG. 2, the system 20 comprises a controller 30 in communication with an input device or operator interface 32, implement sensors 34, machine sensors 36, positioning system 38, and perception systems 40, all of which may be on-board the machine 24. The controller 30 comprises any non-transitory computer readable medium having stored thereon computer-executable instructions, such as, at least one computer processor. The controller 30 receives input from the operator through operator interface 32. Operator interface 32 may include one or more joysticks, steering wheels, pedals, keyboards, touchscreens, displays, or the like, for manipulation of the machine 24 by the operator. The implement sensors 36 may comprise sensors configured to measure implement or tool position, load pressure, pin angle, actuator displacement, and the like. The machine sensors 36 may comprise sensors configured to measure machine speed, engine speed, transmission gear, steering angle, articulation angle, and the like. The positioning system 38 may identify a current location, time or position of the machine 24 and may comprise a navigation system which uses the global positioning system (GPS), an inertial measurement unit (IMU), a dead reckoning procedure, perception-based localization (PBL), or a combination thereof. The system 20 also comprises on-board and off-board perception systems 40, which may detect objects, personnel, or other machines close to the machine 24. The perception systems 40 may use radar, lidar, cameras, or a combination thereof for object and personnel detection.

Algorithms or sets of instructions for monitoring the operation of the machine 24 performed by the operator and detecting the coachable actions of the operation are preprogrammed into a memory of the controller 30. In one aspect, the controller 30 is programmed to include, among other things, an algorithm to detect a type of operation being performed on the machine 24 by the operator. Data sent to the controller 30 from the operator interface 32, implement sensors 34, machine sensors 36, positioning system 38, and perception systems 40 during the operation is used to determine the type of operation being performed.

For example, from signals sent by the perception systems 40, the controller 30 can determine that the machine 24 is approaching a pile of material. From signals sent by the positioning system 38, the controller 30 can determine a GPS location of the machine 24 relative to the pile using positioning system 38. From signals sent by the operator interface 32, the controller 30 can determine commands to lift a linkage and the bucket 26. From signals sent by the implement sensors 34 (e.g., pressure sensor in the bucket 26), the controller 30 can determine that material is being loaded into the bucket 26; and from signals sent by the machine sensors 36, the controller can determine an engine speed and transmission gear. Based on a combination of this data, the controller 30 detects that the machine 24 is digging.

The controller 30 is also programmed to include a coaching point detection algorithm 42, which detects a coaching point for analysis during the determined type of operation. The coaching point is a specific action to monitor depending on the type of operation being performed. Expert operators and trainers may identify the coaching point based on common practices of novice operators who need coaching to perform the specific action in an efficient or safe manner, or to achieve an optimal performance of the machine 24. For example, one coaching point for the wheel loader that the controller can check for when digging is being done is excessive articulation. Wheel loaders generally steer via articulation, which includes a pair of hydraulic cylinders connected between a front frame and a rear frame on opposing sides of an articulation point. Each cylinder may be selectively actuated (e.g., extended and retracted) to pivot the front frame with respect to the rear frame and steer the wheel loader. To achieve an efficient performance of the machine 24, it may be optimal for the machine 24 to enter the pile straight on, not articulated.

Other examples of coaching points for the wheel loader may be, without limitation, not setting tires of the wheel loader properly, loading with lift only and not using bucket curl, improper bucket angle during dig, and loading the bucket 26 using back and forth articulation. There may be a list of various coaching points, each coaching point having a detection algorithm to detect when the coaching point occurs during the operation. Thus, during the determined type of operation, the controller 30 may be checking for more than one coaching point (e.g., during dig, the controller 30 may be checking for articulation and improper bucket angle). In addition, coaching points may vary depending on the particular machine 24. For example, one coaching point for an articulated truck may be improper positioning of the articulated truck relative to a load location, while a coaching point for an excavator may be overextending a boom when swinging. Other coaching points are certainly possible.

Expected data for each coaching point, such as a predetermined set of parameters in accordance with an ideal operating method for the type of operation, may be included in the coaching point detection algorithm 42 preprogrammed into the memory associated with the controller 30. The controller 30 then compares actual data sent from the operator interface 32, implement sensors 34, machine sensors 36, positioning system 38, and perception systems 40 during the operation to the expected data for the type of operation being performed, as preprogrammed in the coaching point detection algorithm 42. If the actual data is not within (i.e. outside of) the expected data, then the controller 30 may flag the coaching point as a non-conforming or coachable action needing improvement, thereby indicating that the operator did not perform according to the ideal operating method. If the actual data is within the expected data, then the controller 30 may not flag the coaching point, or alternatively, flag the coaching point as a conforming action indicating that the operator did perform according to the ideal operating method.

For instance, with the coaching point example of articulation during dig, when the controller 30 determines that the machine 24 is digging (as described above), the coaching point detection algorithm 42 monitors the articulation angle of the machine 24. The articulation angle of the machine 24 may be detected by the machine sensors 36 (e.g., cylinder position sensor or articulation joint sensor) and sent to the controller 30. The coaching point detection algorithm 42 then compares the detected or actual articulation angle to expected data for the articulation angle while digging.

For example, since it may be optimal for the machine 24 to enter the pile straight on, the expected data for the articulation angle while digging may be less than fourteen degrees (14°) and greater than negative fourteen degrees (−14°) according to an ideal operating method for the machine 24. Other values for the expected data parameters for the articulation angle are certainly possible. If the actual articulation angle is outside the expected data, e.g., greater than fourteen degrees (14°) or less than negative fourteen degrees (−14°), then the operator did not perform according to the ideal operating method and the controller flags the coaching point, such as a coachable action needing improvement. If the actual articulation angle is within the expected data, e.g., less than fourteen degrees (14°) and greater than negative fourteen degrees (−14°), then the operator did perform according to the ideal operating method and the controller may not flag the coaching point. Alternatively, the coaching point may be flagged as a conforming action in accordance with the expected data.

At an end of a training session or when an engine of the machine 24 is idle, the operator may review an image or recreation of the flagged coaching points. For example, the operator can view an image of a coachable action to learn from his own mistakes, and the operator can view an image of a conforming action to observe actions he performed correctly. For scene recreation of a coachable action or a conforming action of the operator's performance, the controller 30 flags the coaching point and stores in its memory data, time, or any other information necessary for a predetermined period of time before, during, and/or after the coaching point is flagged. For instance, in the coaching point example of articulation during dig, when the coaching point is flagged, the controller 30 stores data for the predetermined period of time from the operator interface 32 (e.g., operator commands related to lever position and linkage position), the machine sensors 36 (e.g., detected articulation angle from the cylinder position sensor or articulation joint sensor), the positioning system 38 (e.g., detected GPS location of the machine), and the perception systems 40 (e.g., location of pile relative to the machine 24). The controller 30 may also store time data indicative of when the coaching point was flagged. The stored data is then retrieved for scene recreation of the coaching point.

In one aspect, the system 20 further comprises an output device or display 44 in communication with a display module 46. The display 44 and display module 46 may both be in communication with the controller 30. The display 44 may comprise a screen, monitor, or the like, for displaying an image of the flagged coaching point. The display module 46 comprises any non-transitory computer readable medium having stored thereon computer-executable instructions, such as a computer processor. The display module 46 may be part of the controller 30 or part of the display 44. Furthermore, the display 44 and display module 46 may or may not be part of the machine 24. For example, the image of the flagged coaching point may be displayed on a monitor within a cab 28 of the machine 24 at the end of his training session. Alternatively, the system 20 may include communications system 48, which may connect to off-board components, such as through cellular, Wi-Fi, and other wired or wireless communication devices. According to this aspect, the controller 30 then sends data to the display 44 and display module 46 located in a manager's office (via the communications system 48) where the image of the flagged coaching point is displayed for coaching the operator.

In accordance with another aspect, the display module 46 includes instructions for simulating an actual action of the flagged coaching point using computer graphics in 2D, 3D, wireframe, or the like. More specifically, the controller 30 sends to the display module 46 the stored data relating to the coaching point that was flagged during the operation. After retrieving the stored data from the controller 30, the display module 46 then generates a simulation of the flagged coaching point on the display 44 using the stored data, as well as other preprogrammed data, such as machine dimensions, linkage or implement dimensions, operator control dimensions and the like.

For instance, in the example of articulation during dig, using the stored data from the operator interface 32 (e.g., operator commands related to lever position and linkage position) the machine sensors 36 (e.g., detected articulation angle from the cylinder position sensor or articulation joint sensor), the positioning system 38 (e.g., detected GPS location of the machine 24 relative to the pile), and the perception systems 40 (e.g., location of pile relative to the machine 24), together with the preprogrammed data (e.g., machine dimensions, linkage or implement dimensions, operator control dimensions), an image of the flagged coaching point, such as, a view of the machine 24 acting in its environment, may be simulated and displayed. Using the stored and preprogrammed data, an image or view of the operator interface 32 or controls in the cab 28 may also be simulated and displayed. Alternatively, views of the machine relative to the worksite from the positioning system 38 may be used for display.

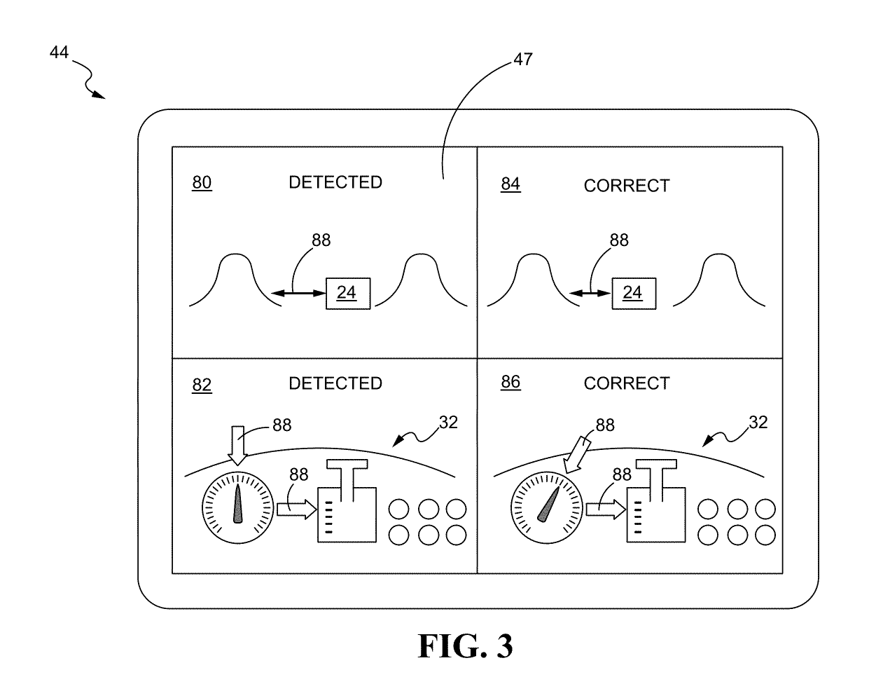

Furthermore, an expected action, such as an optimal or predetermined technique for operation of the machine 24 in accordance with the expected data, can be programmed into the controller 30 or display module 46. Based on the stored data and the expected data, the controller 30 then determines the expected action to display. The display module 46 then displays the expected action together with the actual action of the flagged coaching point. For example, as shown schematically in FIG. 3, the display 44 may show on a screen 47 the actual action synchronized and side-by-side with the expected or optimal action. A view 80 of the machine 24, or a portion of the machine, relative to the worksite along with a view 82 of the operator interface 32 during the flagged coaching point may be displayed on the screen 47 synchronized and side-by-side with a view 84 of the machine 24 relative to the worksite along with a view 86 of the operator interface 32 in accordance with the expected action. The display module 46 may also overlay the expected action onto the actual action for display.

According to one aspect, the controller 30 determines which view to display based on the type of operation performed and the coaching point flagged, as preprogrammed in the memory associated with the controller 30. For example, in the coaching point example of articulation during dig, the controller 30 may be programmed to display a top view (looking down on the machine 24 acting in its environment) such that the articulation angle of the machine 24 is easily discernible by the operator. In another aspect, the operator can change or alternate between views in order to observe the actual and expected simulations from different angles. The controller 30 and display module 46 may be configured to simulate various views from different angles on the display 44, as prompted by the operator through the operator interface 32.

In addition, the displayed simulation may be annotated by the controller 30 or display module 46 with further graphics, such as arrows 88, numbers, words, and the like, for more in-depth coaching. Audio description may also be provided by the controller 30 or display module 46 together with and synchronized to the displayed simulation. The audio description may be provided before, after, or during the displayed simulation as well. In one example, the audio description may describe the expected or proper techniques for operation. The audio description may also describe errors of the operator's performance, the effect of those errors and how to correct them. Furthermore, the displayed simulation may include links to other coaching materials, e.g., texts, manuals, other simulations, videos, audio description, automated demonstrations, or combinations thereof.

According to another aspect, the system 20 includes at least one camera 50 for capturing operation of the machine 24. For example, the cameras 50 can be on-board the machine 24, such as inside the cab 28 to capture manipulation of the operator interface 32 or out of the cab 28, to capture linkage or implement function and interaction with the worksite. In another example, the camera 50 may be placed outside of the cab 28, such as on a pole placed on top of a body of the machine 24, in order to capture a bird's eye view of the machine 24, its linkages or implements interacting with the worksite. The cameras 50 can be off-board the machine 24, as well, in order to capture a view of the entire machine 24 interacting with the worksite. As an example, there may be four cameras 50, each in a different position, monitoring the machine 24 in order to get various views of the machine 24 in its environment. In other examples, the camera 50 may be placed on a trailer overlooking the worksite, or the cameras 50 may be placed on different poles around the worksite in order to access bird's eye views off-board the machine. Other arrangements for the cameras 50 on-board and off-board the machine 24 are certainly possible.

The cameras 50 are in communication with the controller 30 and display module 46. The controller 30 may be configured to control the cameras 50. The controller 30 sends to the display module 46 the stored time data indicative of when the coaching point occurred. Based on the stored time data, the display module 46 then obtains camera data from the cameras 50 for a time period surrounding the flagged coaching point and displays a recorded video of the actual action during the flagged coaching point.

Furthermore, camera data for a video of a pre-recorded or expected action, such as an optimal technique for operation of the machine 24 in accordance with the predetermined set of parameters, may be stored in the controller 30 or display module 46. Based on the type of operation performed and coaching point flagged, the controller 30 may determine the expected action to display. The display module 46 then displays the expected action together with the recorded video of the actual action. For example, the display 44 may show the actual action synchronized and side-by-side with the expected or proper action.

The actual and/or expected actions may include a view of the operator manipulating the operator interface 32, a view of the implement interaction with the worksite, or a view of the entire machine 24 interacting with the worksite. The controller 30 determines which view to display based on the type of operation performed and the coaching point flagged, as preprogrammed in the memory associated with the controller 30. In another aspect, the operator can change or alternate between views in order to observe the actual and expected actions from different angles. The controller 30 and display module 46 may be configured to display various views from different angles on the display 44, as prompted by the operator through the operator interface 32.

In another aspect, multiple views may be displayed at the same time. For example, a view of the operator manipulating the interface 32 within the cab 28 may be presented on the display 44 synchronized with and alongside a view of the implement interaction with the worksite in order to show how the operator used the interface 32 to control the machine. Furthermore, as shown best in FIG. 3, views 80, 82 of both the operator manipulating the interface 32 and the implement interaction with the worksite during the actual action may be displayed synchronized and side-by-side with both prerecorded videos 84, 86 of an operator manipulating the interface 32 and the implement interaction with the worksite according to expected action. In so doing, the operator can observe how he used the inputs versus how they should have been used during that action.

In addition, the displayed videos may also be annotated by the controller 30 or display module 46 with graphics, such as arrows 88, numbers, words, and the like, for more in-depth coaching (e.g., outlining proper articulation angle). Audio description may also be provided by the controller 30 or display module 46 together with and synchronized to the displayed videos. The audio description may be provided before, during, or after the displayed videos as well. In one example, the audio description describes the predetermined or proper techniques for operation, in this aspect. The audio description may also describe errors of the operator's performance, the effect of those errors and how to correct them. Furthermore, the controller 30 and display module 44 may be configured to provide various views from different angles, depending on the type of operation being performed, the coachable action detected, or input from the operator.

In another aspect, the displayed videos may include links to other coaching materials, e.g., texts, manuals, simulations, other videos, audio description, automated demonstrations, or combinations thereof. According to yet another aspect, the computer-generated simulation of the expected action may be displayed together with the recorded video of the actual action during the flagged coaching point. Alternatively, the pre-recorded video of the expected action may be displayed together with the computer-generated simulation of the actual action.

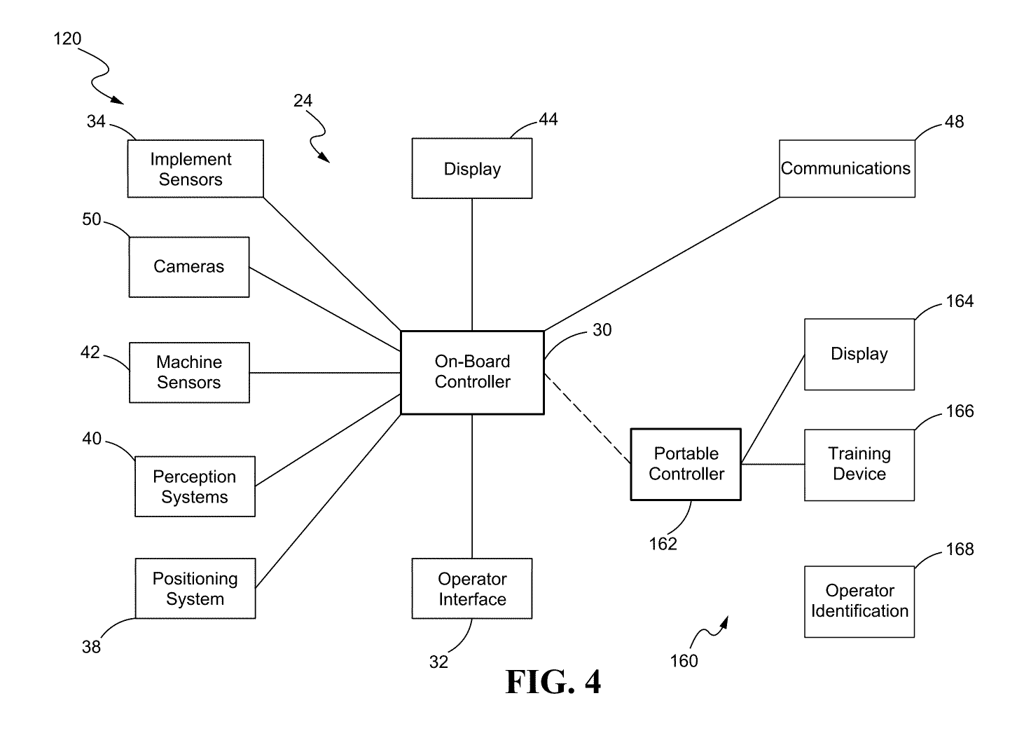

Referring now to FIG. 4, the system 120 comprises a portable apparatus 160 that is not integral to the machine 24, in this aspect. The portable apparatus 160 includes a controller 162 in communication with a display 164, a training device 166 containing the coaching point detection algorithm, and an operator identification device 168 for the operator to identify himself and to allow the tracking of individual progress, in this aspect. The controller 162 of the portable apparatus 160 may be operatively configured to communicate with the controller 30 of the machine 24. Algorithms or sets of instructions for monitoring operator performance, flagging coaching points, and displaying actual and expected actions may be preprogrammed into a memory of the controller 162, training device 166, or a display module of the display 164, as described above with the controller 30 and display module 46.

Thus, when connected to the machine 24, the controller 162 of the portable apparatus 160 uses and collects data from the controller 30 and other parts (i.e. operator interface 32, implement sensors 34, machine sensors 36, positioning system 38, and perception systems 40) of the machine 24 in order to recreate the flagged coaching point. The other features described above with regard to the system 20, controller 30, display 44, and display module 46 may also be incorporated into the portable apparatus 160.

### INDUSTRIAL APPLICABILITY

In general, the foregoing disclosure finds utility in various industrial applications, such as in earthmoving, industrial, construction and agricultural machines. In particular, the disclosed operator coaching system and method may be applied to wheel loaders, excavators, tract-type tractors, motor graders, articulated trucks, pipe layers, backhoes, and the like. By applying the disclosed system and method to a machine, the operator's performance may be monitored. Furthermore, any action of a coaching point during the operator's performance may be flagged and recreated for display. Moreover, the actual action may be displayed together with an expected action (i.e. demonstrating a proper technique). In so doing, the operator can observe his mistakes and learn how to correct his operational skills, thereby facilitating the efficient or optimal performance of the machine. Thus, by improving operator skill level, machine performance and fuel efficiency may be increased.

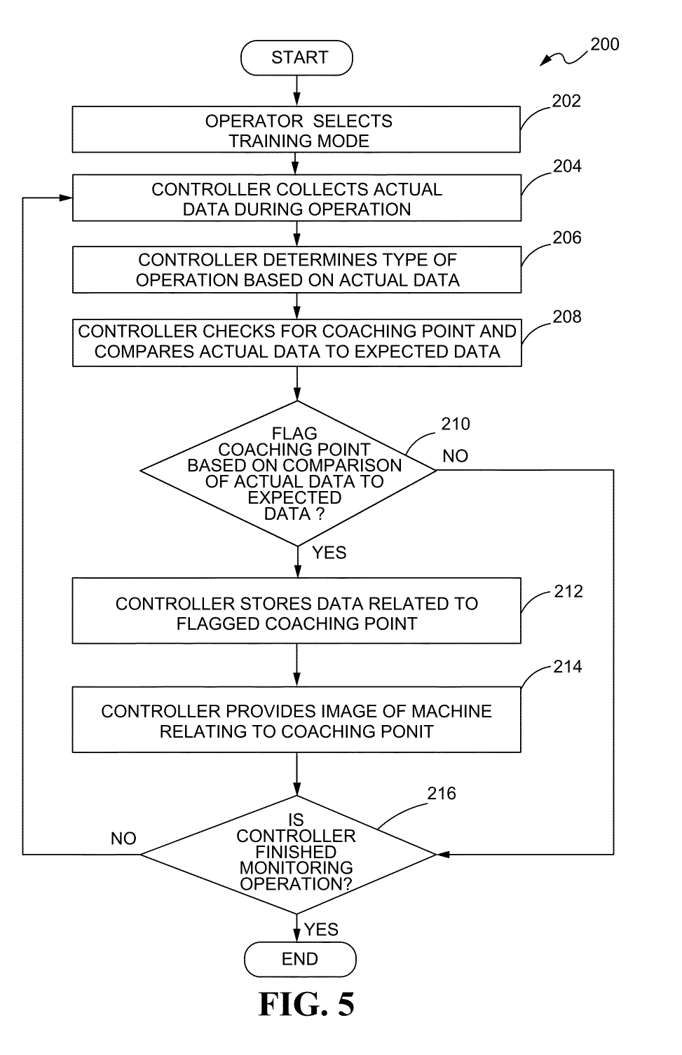

Turning now to FIG. 5, a flowchart outlining the method 200 for coaching the operator of the machine is shown, according to another embodiment of the present disclosure. At a first step 202 of the method 200, the operator selects input (via the I/O device) to put the machine in a training mode. When the controller receives input to enable the training mode, the controller starts monitoring the operator's performance. At a next step 204, the controller collects actual data during an operation of the machine performed by the operator. For example, in order to monitor the operation, data may be received from operator interface, implement sensors, machine sensors, positioning system, and perception systems during the operation. At a next step 206, the controller determines a type of operation being performed based on the actual data. At a next step 208, the controller checks for coaching points depending on the type of operation being performed and compares the actual data to expected data for each coaching point. For example, the controller includes the coaching point detection algorithm, which includes coaching points and expected data for each coaching point preprogrammed into the memory of the controller.

Next, at a step 210, the controller determines whether to flag the coaching point based on the comparison of actual data to expected data. If the actual data is within the expected data, then the controller may not flag the coaching point, and the method may proceed to step 216. Alternatively, if the actual data is within the expected data, the controller can flag the coaching point as an action conforming to ideal operating methods. If the actual data is outside of the expected data, then the controller can flag the coaching point as a non-conforming or coachable action needing improvement and coaching.

If the controller flags the coaching point (e.g., as conforming or as non-conforming), then the method proceeds to step 212, in which the controller stores data related to the coaching point for scene recreation. At a next step 214, the controller provides an image of the machine relating to the coaching point based on the stored data from step 212. Lastly, at a step 216, the controller determines whether it is finished monitoring the operation. If it is finished monitoring the operation, then the method is at an end. If the controller is not finished monitoring the operation, then the method repeats again at step 204. The controller may be continuously monitoring the operation and collecting data throughout the operation and steps of the method.

In the example where the machine is a wheel loader, as shown in FIG. 1, at the first step 202, the operator selects to go into training mode on the machine. At the next step 204, the controller receives actual data from the operator interface, implement sensors, machine sensors, positioning system, and perception systems. At the next step 206, based on the actual data received, the controller can determine the type of operation being performed by the wheel loader, e.g., digging, as described above. At the next step 208, once the controller determines that the wheel loader is digging, the controller checks for coaching points related to digging and compares actual data to expected data.

Another example of a coaching point the controller can check for when digging is improper setting of the tires during dig. To achieve an efficient performance of the machine, it may be optimal to set the tires by providing a high force on the tires when digging. To detect the force on the tires, the controller may monitor pressure in the bucket, such as a pressure spike or an increase in pressure within a short amount of time. More specifically, the expected data for properly setting the tires may be a pressure in the bucket greater than ten thousand kilopascals (>10,000 kPa) in 0.5 seconds. Other values are certainly possible.

When the controller receives data from the operator interface relating to commands for lifting the bucket, the coaching point detection algorithm may compare actual data received from the implement sensors (e.g., bucket sensor) to the expected data, at the step 206. If the bucket sensor detects a pressure spike of less than ten thousand kilopascals (<10,000 kPa) in 0.5 seconds, then the operator did not perform according to the ideal operating method, and at the next step 208, the controller flags the coaching point as a coachable action needing improvement. If the actual pressure spike is greater than ten thousand kilopascals (>10,000 kPa) in 0.5 seconds, then the operator did perform according to the ideal operating method, and at the next step 210, the controller may not flag the coaching point, or alternatively, flag the coaching point as a conforming action in accordance with the expected data.

At the next step 212, if the coaching point of improper setting of the tires is flagged, then the controller stores data related to lever position and linkage position from the operator interface, pressure load in the bucket from the implements sensors, detected GPS location of the machine from the positioning system, and the location of the pile relative to the machine from the perception systems, as well as time data indicative of when the coaching point was flagged. At the next step 214, the controller provides an image (e.g., computer simulation or video) of the machine based on the stored data as well as preprogrammed data. For this particular coaching point, the controller may be programmed to show a side view of the wheel loader digging in order to show the setting of the tires. Lastly, at the step 216, the controller determines whether it is finished monitoring the operation.

In another example where the machine is an articulated truck, as shown in FIG. 6, at the first step 202, the operator selects to go into training mode. At the next step 204, the controller receives actual data from the operator interface, implement sensors, machine sensors, positioning system, and perception systems. At the next step 206, based on the actual data received, the controller can determine the type of operation being performed, such as carrying and dumping a payload. For example, from signals sent by the implement sensors (e.g., payload weight sensor in the dump body), the controller can determine there is a payload in the dump body. From signals sent by the operator interface, the controller can determine commands to reverse the truck, stop the truck, and lift the dump body. From signals sent by the machine sensors, the controller can determine an engine speed and transmission gear. From signals sent by the perception systems, the controller can detect the dump location (e.g., a cliff or wall of the dump location). From signals sent by the positioning system, the controller can determine a GPS location of the truck relative to the dump location. Based on a combination of this data, the controller detects that the truck is carrying and dumping the payload onto the dump location.

At the next step 208, once the controller determines that the dump truck is carrying and dumping the payload onto the dump location, the controller checks for coaching points related to this type of operation and compares actual data to expected data. One example of a coaching point the controller can check for when carrying and dumping the payload is improper positioning of the truck relative to the dump location. Expected data for an optimal positioning of the truck to the dump location may be about five meters (5 m) to eight meters (8 m) from a back edge of the truck to the wall of the dump location. Other distances and configurations are certainly possible.

The controller detects the distance from the back edge of the truck to the wall (via signals from the positioning system) when the operator inputs the command to lift the dump body (via signals from the operator interface). The controller then compares the actual distance when dumping to the expected distance, and if the actual distance between the back edge of the truck and the wall of the dump location is less than five meters (5 m) or greater than eight meters (8 m), then at the next step 210, the controller flags the coaching point as a coachable action needing improvement. If the actual distance is within five to eight meters (5-8 m), then the controller may not flag the coaching point, or alternatively, flag the coaching point as a conforming action in accordance with the expected data.

At the next step 212, if the coaching point of improper positioning of the truck relative to the dump location is flagged, then the controller stores data related to the detected GPS location of the truck and the dump location from the positioning system (at the time the payload was dumped), as well as time data indicative of when the coaching point was flagged. At the next step 214, the controller provides an image (e.g., computer simulation or video) of the machine based on the stored data as well as preprogrammed data. For this particular coaching point, the controller may be programmed to show a top view of the truck in relation to the dump location when dumping in order to show the distance and positioning between each. Lastly, at the step 216, the controller determines whether it is finished monitoring the operation.

It will be understood that the flowchart in FIG. 5 is shown and described as an example only to assist in disclosing the features of the systems and that more or fewer steps than shown, in a same or different order, may be included in the method 200 corresponding to the various features described above for systems without departing from the scope of the present disclosure.

Other innovative coaching and training features are also disclosed. For example, the display module may generate a simulation of the flagged coaching point based on the stored data in the controller. The display module may generate the simulation on the display in 2D, 3D or wireframe using computer graphics. In another example, a camera may be used to capture a video of the coaching point, and the video may be later displayed for viewing by the operator or his manager. Furthermore, expected actions in accordance with proper techniques may be displayed alongside the simulation or video of the flagged coaching point in order to show the operator the correct way to operate the machine.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments of the disclosure, these features are not limited to use with only the embodiment with which they are described, but instead may be used together with or separate from, other features disclosed in conjunction with alternate embodiments.

What is claimed is:

1. A method for coaching an operator of a machine having a controller, the method comprising:
the controller collecting actual data related to an operation of the machine performed by the operator;
the controller determining a type of operation being performed based on the actual data;
the controller comparing the actual data to expected data for the type of operation being performed;
the controller flagging a coaching point based on the comparison of actual data to expected data; and
the controller providing an image of the machine relating to the coaching point.

2. The method of claim 1, further comprising the controller displaying the coaching point together with an expected action in accordance with the expected data.

3. The method of claim 2, further comprising the controller displaying the coaching point side by side and synchronized to the expected action.

4. The method of claim 2, further comprising the controller displaying the expected action overlaid on the coaching point.

5. The method of claim 1, further comprising the controller displaying at least one of a view of the machine relative to a worksite during the coaching point and a view of operator controls during the coaching point.

6. The method of claim 1, further comprising the controller using computer graphics to simulate the coaching point based on sensor data and operator input.

7. The method of claim 1, further comprising the controller controlling a camera to capture the coaching point and provide a video of the coaching point.

8. The method of claim 1, further comprising the controller obtaining time data indicative of when the coaching point occurred.

9. The method of claim 1, further comprising the controller determining a view of the machine to display based upon the coaching point flagged.

10. A system for coaching an operator of a machine, comprising:
a controller configured to:
collect actual data during an operation of the machine performed by the operator,
determine a type of operation being performed based on the actual data;
compare the actual data to expected data for the type of operation being performed,
detect a coachable action if the actual data is outside of the expected data, and
provide an image of the coachable action; and
a display module in communication with the controller, the display module configured to display the image of the coachable action on an output device.

11. The system of claim 10, wherein the controller and display module are further configured to display on the output device at least one of a view of the machine relative to a worksite during the coachable action and a view of operator controls during the coachable action.

12. The system of claim 10, wherein the controller and display module are further configured to annotate the image of the coachable action, and provide an audio description of the coachable action.

13. The system of claim 10, further comprising a plurality of sensors in communication with the controller, the plurality of sensors configured to detect at least one of implement position, load pressure, pin angle, actuator displacement, machine speed, engine speed, transmission gear, steering angle and articulation angle.

14. The system of claim 13, further comprising an input device in communication with the controller, the input device configured to receive input from the operator for operating the machine.

15. The system of claim 14, wherein the controller is configured to compare data received from the plurality of sensors and the input device with the expected data in order to detect the coachable action.

16. The system of claim 15, wherein the display module is further configured to:
simulate with computer graphics the coachable action and an expected action in accordance with the expected data, and
display on the output device the coachable action together with the expected action.

17. The system of claim 15, further comprising a camera in communication with the controller and the display module, the camera configured to capture the coachable action and provide a video of the action; and wherein the display module is further configured to display on the output device the video of the action captured by the camera together with a video of an expected action in accordance with the expected data.

18. A non-transitory computer readable medium having stored thereon computer-executable instructions which when executed by a computer coaches an operator of a machine, the thereon computer-executable instructions comprising instructions for:
collecting actual data during an operation of the machine performed by the operator;
determining a type of operation being performed based on the actual data;
comparing actual data to expected data for the type of operation being performed;
detecting a coaching point based on the comparison of actual data to expected data;
storing data related to the coaching point; and
displaying an image of the coaching point using the stored data.

19. The non-transitory computer readable storage medium of claim 18, further comprising instructions for generating a simulation of the coaching point and an expected action using computer graphics, and instructions for displaying the simulation of the coaching point together with the expected action.

20. The non-transitory computer readable storage medium of claim 18, further comprising instructions for recording a video of the coaching point using a camera, and instructions for displaying the video of the coaching point together with a video of an action in accordance with the expected data.
